(19) United States
(12) Patent Application Publication
(10) Pub. No.: US 2011/0255931 A1
(43) Pub. Date: Oct. 20, 2011

(54) Hole Saw Arbor System

(75) Inventors: Mark Murdie, Jedburgh (GB); Richard John Sharp, Singapore (SG)

(73) Assignee: THE L.S. STARRETT COMPANY, Athol, MA (US)

(21) Appl. No.: 13/091,100

(22) Filed: Apr. 20, 2011

Related U.S. Application Data
(60) Provisional application No. 61/325,915, filed on Apr. 20, 2010.

(51) Int. Cl. B23B 51/04; B23B 51/00

(52) U.S. Cl. 408/204; 408/239 R

(57) ABSTRACT

A hole saw arbor system includes a tool-bit holder comprising a body having a proximal end and a distal end, the proximal end configured to be coupled to and driven by a driving device. A substantially longitudinal tool-bit holder bore may extend from the proximal end to the distal end of the body, the bore configured to receive a drill bit. The system further includes an arbor configured to be releasably coupled to a portion of the drill bit. The arbor may include a body having a proximal end and a distal end, the proximal end configured to matingly engage the distal end of the tool-bit holder when the arbor is coupled to the drill bit. The distal end may be configured to be coupled to a hole saw. A substantially longitudinal arbor bore may extend from the proximal end to the distal end of the body, the arbor bore being configured to receive the drill bit. The arbor may further include a locking mechanism positioned within a portion of the body, the locking mechanism configured to releasably couple the arbor to at least a portion of the drill bit when the drill bit is within the arbor bore.

### CROSS-REFERENCE TO RELATED APPLICATIONS

The present application claims the benefit of U.S. Provisional Patent Application Ser. No. 61/325,915, filed Apr. 20, 2010, the entire disclosure of which is incorporated herein by reference.

### FIELD

The present disclosure relates generally to hole saws, and, more particularly, to a hole saw arbor system.

### BACKGROUND

A hole saw, also known as a hole cutter, is configured designed to cut a circular opening in a variety of materials, such as metal or wood. A hole saw generally may include an arbor and a saw blade assembly connected with the arbor. An arbor for a hole saw may include an arbor body with an end portion that engages a corresponding end of the saw blade to secure the hole saw to the arbor. The arbor may also carry a drill bit for boring a centering hole.

The arbor can be rotationally driven by a driving device, such as an electric motor, to rotate the saw blade. In order to effectively operate the hole saw, the arbor and saw blade must be securely connected to the driving device. Generally, a tool-bit locking mechanism, such as a drill chuck, may be used to secure and couple the arbor and saw blade to the driving device.

In some situations, an operator must frequently change tools, including hole saws, while working on a particular project. The operator may be in a position where quickly exchanging one tool for another may be cumbersome and/or awkward. In order to change tool-bits held within current tool-bit holders, an operator may be required to manipulate a tool-bit locking mechanism. For example, to change tools, including hole saws, held by a conventional three-jaw chuck, the operator may be required to loosen the jaws to either remove or insert a tool-bit, and tighten the jaws to secure the tool-bit. This may require the operator to use both hands to perform an exchange. Because of the inconvenience inherent in exchanging tools in such tool-bit holders, the operator's work may be slowed.

In some situations an operator may not be able to access the securing or releasing mechanism of the tool-bit holder. For example, such securing/releasing mechanism may be inserted into a handle, such as a screw driver handle, such that, to directly activate a sleeve or other mechanism for securing/releasing the tool-bit may be difficult. These situations may require that a tool-bit be automatically secured or released by the tool-bit holder as the tool-bit is inserted or pulled out of the tool-bit holder.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a side view of a hole saw arbor system consistent with the present disclosure;

FIG. 2 is an exploded view of the system of FIG. 1;

FIG. 3 is a perspective view of the drill bit coupled to the tool-bit holder of the system of FIG. 1;

FIG. 4 is a side view of the drill bit of the system of FIG. 1;

FIG. 5 is a perspective view of the arbor of the system of FIG. 1;

FIG. 6 is an exploded view of the arbor of the system of FIG. 1;

FIG. 7 is a side view of the arbor of the system of FIG. 1;

FIG. 8A is side view of the arbor of FIG. 7, illustrating internal features and/or surfaces;

FIG. 8B is a bottom view of the arbor of FIG. 7, illustrating internal features and/or surfaces;

FIG. 8C is a rear (proximal end facing) view of the arbor of FIG. 7, illustrating internal features and/or surfaces;

FIG. 9A is a rear (proximal end facing) sectional view of the arbor of FIG. 7 with the release button of the locking mechanism in a first release button position;

FIG. 9B is a rear (proximal end facing) sectional view of the arbor of FIG. 7 with the release button of the locking mechanism in a second release button position; and

FIG. 10 is a side view of the hole saw arbor system of FIG. 1 with the locking mechanism of the arbor disengaged from the drill bit.

### DETAILED DESCRIPTION

The present disclosure is generally directed to a hole saw arbor system. In general, a hole saw arbor system consistent with the present disclosure may include a tool-bit holder configured to be coupled to and driven by a driving device. The system may also include an arbor configured to engage and be coupled to the tool-bit holder and a saw blade configured to be coupled to the arbor. Additionally, the system may include a drill bit configured to engage and be coupled to the tool-bit holder and arbor.

A hole saw arbor system consistent with the present disclosure provides a relatively quick attachment and release of an arbor and saw blade and/or tool bit to and from a driving device, thus increasing the ease and reducing the time needed to change hole saws.

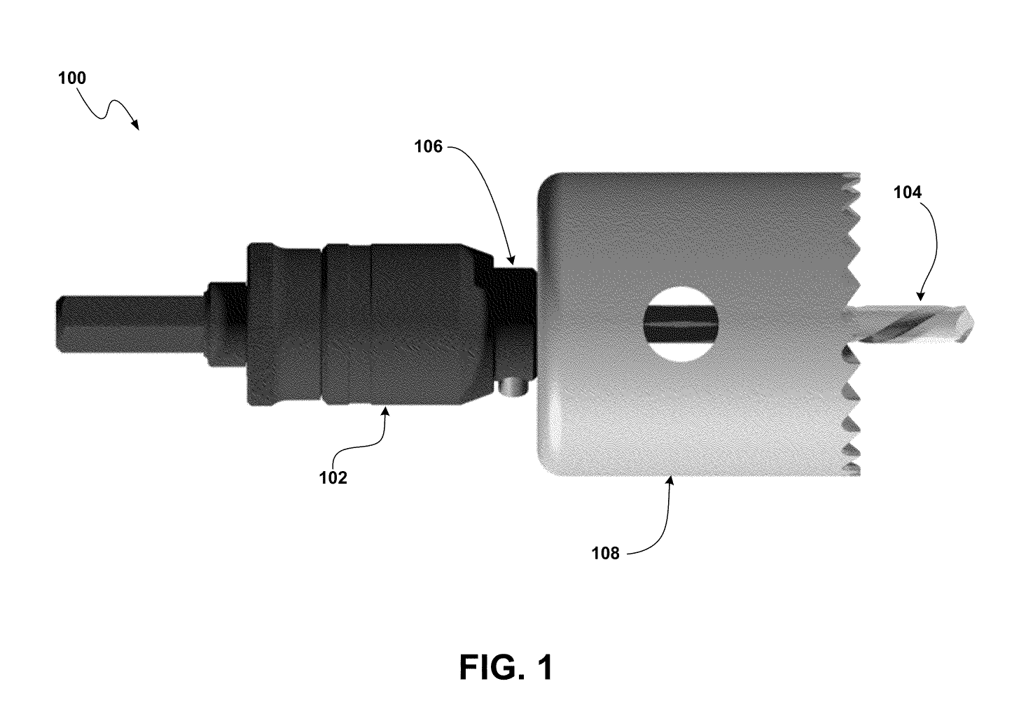

FIG. 1 is a side view of a hole saw arbor system consistent with the present disclosure. Generally, a hole saw arbor system 100 may include a tool-bit holder 102 configured to be coupled to and driven by a driving device (not shown). The system 100 may also include a drill bit 104 configured to be removably coupled to the tool-bit holder 102. Additionally, the system 100 may include an arbor 106 configured to be removably coupled to the tool-bit holder 102 and/or the drill bit 104 and a saw blade 108 configured to be removably coupled to the arbor 106. When driven by a driving device, a portion of the tool-bit holder 102 may be configured to engage a portion of the arbor 106 and drive the arbor 106, thereby driving the saw blade 108. Additionally, the tool-bit holder 102 may be configured to drive the drill bit 104.

The term “driving device” a tool configured for providing a rotational force for rotating the tool-bit holder 102, e.g. using electro-motive force or user-generated force. In one embodiment, for example, the tool may be a conventional electric or user-operated drill. It should be noted, however, that the present disclosure is not limited to a drill and may be used with any adaptable tool. The term “tool-bit holder” refers to a component capable of securing and holding rotating tools and/or materials. In one embodiment, the tool-bit holder may include a quick release chuck. In other embodiments, the chuck may be selected from the group consisting of self-centering, independent-jaw, multi-jaw, collet, Special Direct System (SDS), magnetic, electrostatic, and vacuum chucks.

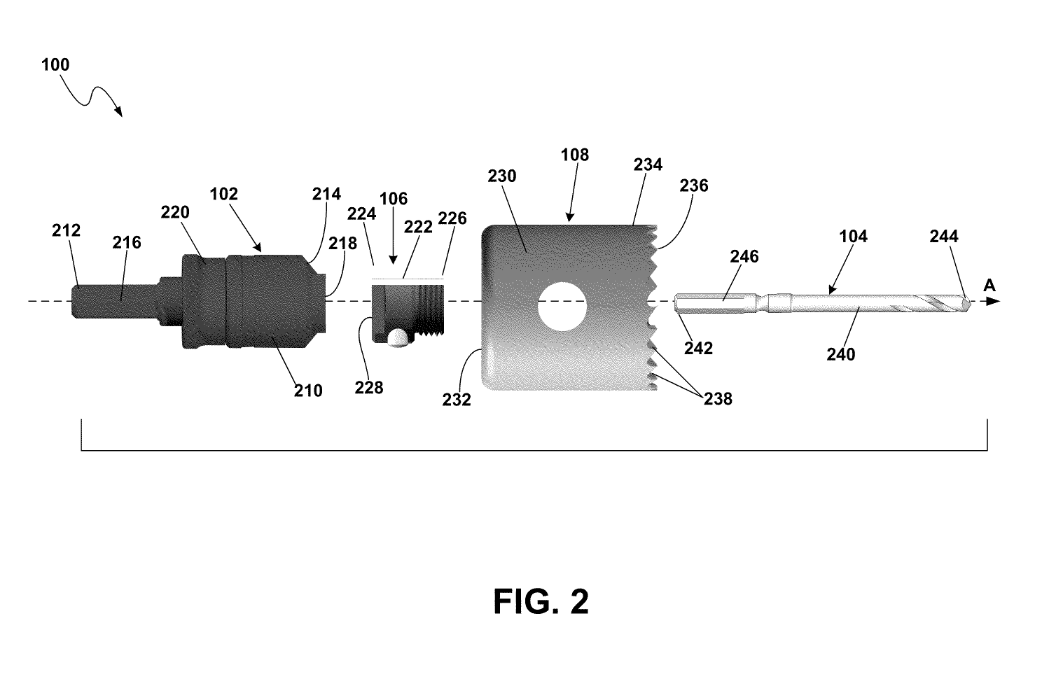

FIG. 2 is an exploded view of the system of FIG. 1. A longitudinal axis A of the system 100 runs from the tool-bit holder 102 through the arbor 106 to the saw blade 108. For purposes of discussion, the longitudinal axis A of the system 100 lies along a horizontal plane. In the illustrated embodiment, the tool-bit holder 102 may include a quick-release mechanism configured to secure a tool, such as the drill bit 104. The tool-bit holder 102 may include a hub (not shown), a collar 210 fixedly attached to the hub, wherein the collar 210 may define a proximal end 212 and a distal end 214. The proximal end 212 may define a shank 216 configured to be coupled to a driving device. In the illustrated embodiment, the shank 216 may define a hexagonally-shaped cross-section. In other embodiments, the shank 216 may be configured to be coupled to a Special Direct System (SDS).

The distal end 214 of the collar 210 may define a collar surface 218, wherein at least a portion of the collar surface 218 may be configured to engage a portion of the arbor 106. The tool-bit holder 102 may also include a sleeve portion 220 slideably mounted along the hub and near the proximal end 212 of the tool-bit holder 102. The sleeve portion 220 may be configured to move along a length of the hub generally along axis A from a first position (shown in FIG. 2) to a second position. The tool-bit holder 102 may further include longitudinal bore (not shown) extending a length of the tool-bit holder 102 along axis A. The bore may be sized and shaped for receiving at least a portion of the drill bit 104. In other embodiments, the bore may be sized and shaped for receiving a variety of tool-bits.

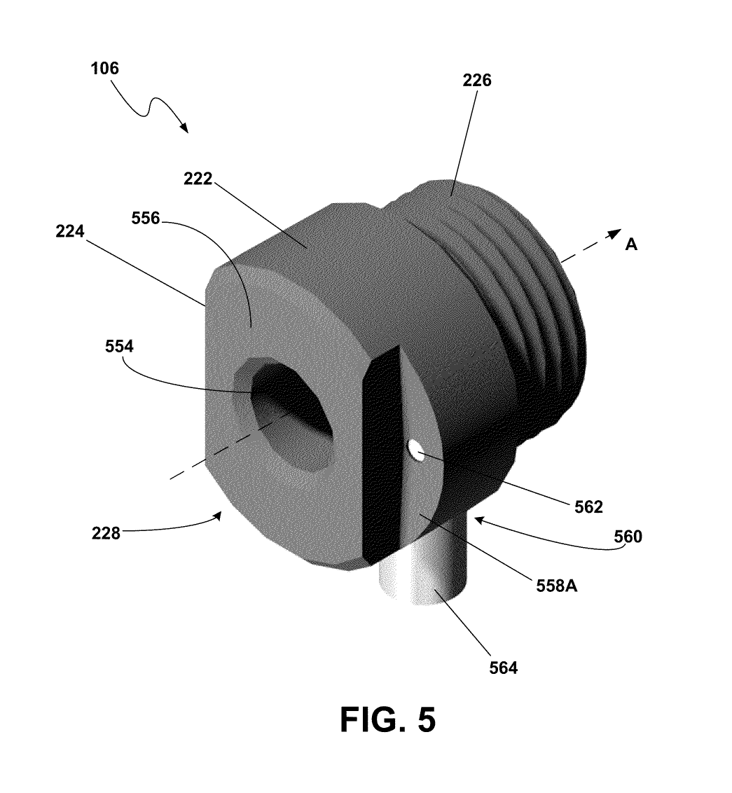

In the illustrated embodiment, the arbor 106 may include a body 222 defining a proximal end 224 and a distal end 226. The proximal end 224 may define a surface 228, wherein at least a portion of the surface 228 may be configured to receive and matingly engage at least a portion of the collar surface 218 of the tool-bit holder 102 when the arbor 106 is coupled to the drill bit 104. The distal end 226 may be configured to be coupled to the saw 108. The arbor 106 may further include longitudinal bore 554 (shown in FIG. 5) extending axially along a length of the arbor 106 from the proximal end 224 to the distal end 226 along axis A. The bore 554 may be sized and shaped for receiving at least a portion of the drill bit 104. In other embodiments, the bore 554 may be sized and shaped for receiving a variety of tool-bits.

In the illustrated embodiment, the saw blade 108 may include hole saw. The saw blade 108 may include a cylindrical body 230 having a proximal end 232 and a distal end 234. The proximal end 232 may be configured to be coupled to the distal end 226 of the arbor 106. For example, the proximal end 232 of the saw blade 108 may define a threaded aperture configured to accept and be coupled to threads (shown in FIG. 5) defined on the distal end 226 of the arbor 106. The distal end 234 of the saw blade 108 may define a cutting edge 236, wherein the cutting edge 236 may define a plurality of teeth 238. In other embodiments, the cutting edge 236 may define a structure and/or materials, such as industrial diamonds, constructed and arranged to cut, grind, tear, score, and/or shred a desired material. The saw blade 108 may be configured to cut a variety of materials, including, but not limited to, wood, plastic, soft plaster, metal, brick, concrete, glass, and/or stone.

In the illustrated embodiment, the drill bit 104 may include a body 240 having a proximal end 242 and a distal end 244. The proximal end 242 may define a hexagonal shank 246 configured to pass through the threaded aperture of the saw blade 108 and the longitudinal bore of the arbor 106 and be received within the longitudinal bore of the tool-bit holder 102, wherein the tool-bit holder 102 is configured to engage and retain the drill bit 104. The distal end 244 may define a cutting edge configured to drill holes into a desired material.

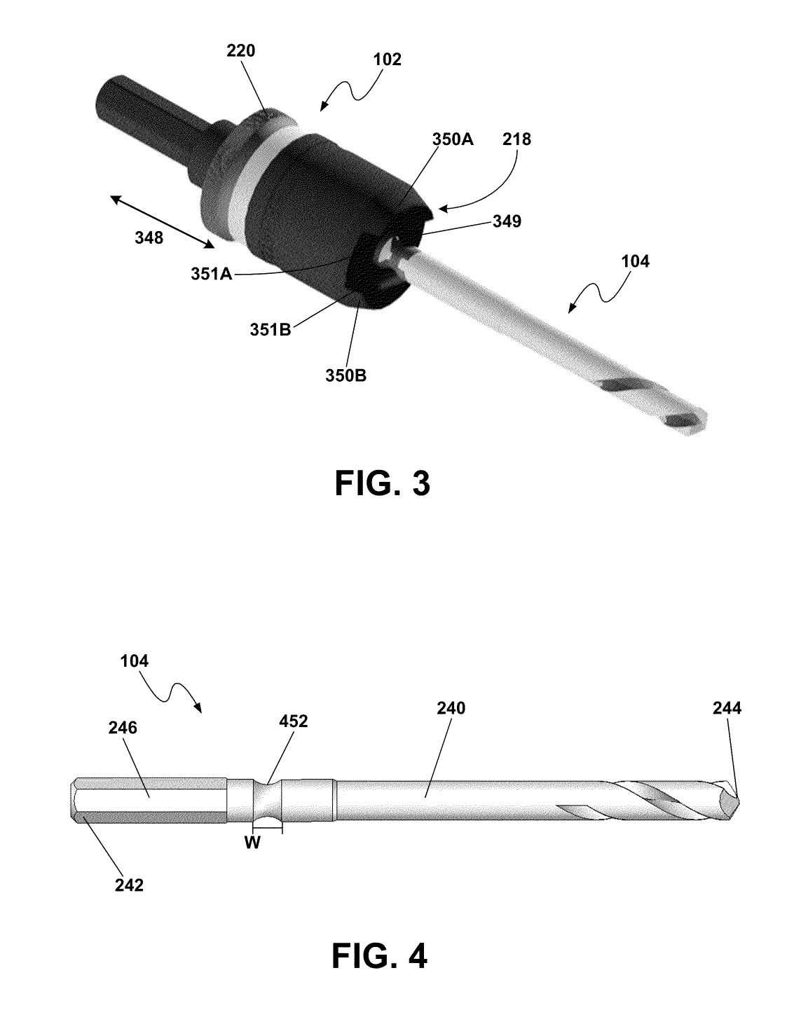

FIG. 3 is a perspective view of the drill bit coupled to the tool-bit holder of the system of FIG. 1. The drill bit 104 may be positioned and received within the longitudinal bore of the tool-bit holder 102. As described earlier, the tool-bit holder 102 may include a quick release chuck for use with a driving device. The quick release chuck may be configured to automatically capture tool-bits, such as a drill bit 104, as they are inserted into the longitudinal bore. As described earlier, the sleeve portion 220 may be configured to move from a first sleeve member position to a second member position as indicated by the double arrow 348. When the sleeve portion 220 is in the first sleeve member position (shown in FIGS. 2-3), the tool-bit holder 102 may be configured to engage and retain the drill bit 104. When the sleeve portion 220 is in the second sleeve member position, the tool-bit holder 102 may be configured to disengage and release the drill bit 104. For example, when desired, replacement of the drill bit 104 can be accomplished by releasing the tool-bit holder's lock on the bit. In one embodiment, a bit may be released from the tool-bit holder 102, specifically a quick release chuck, by pulling back the sleeve portion 220 from the first sleeve member position to a second sleeve member position, which releases the hold on the hexagonal shank of the drill bit 104. Depending on the type of tool-bit holder, the mechanism by which a bit may be released may vary.

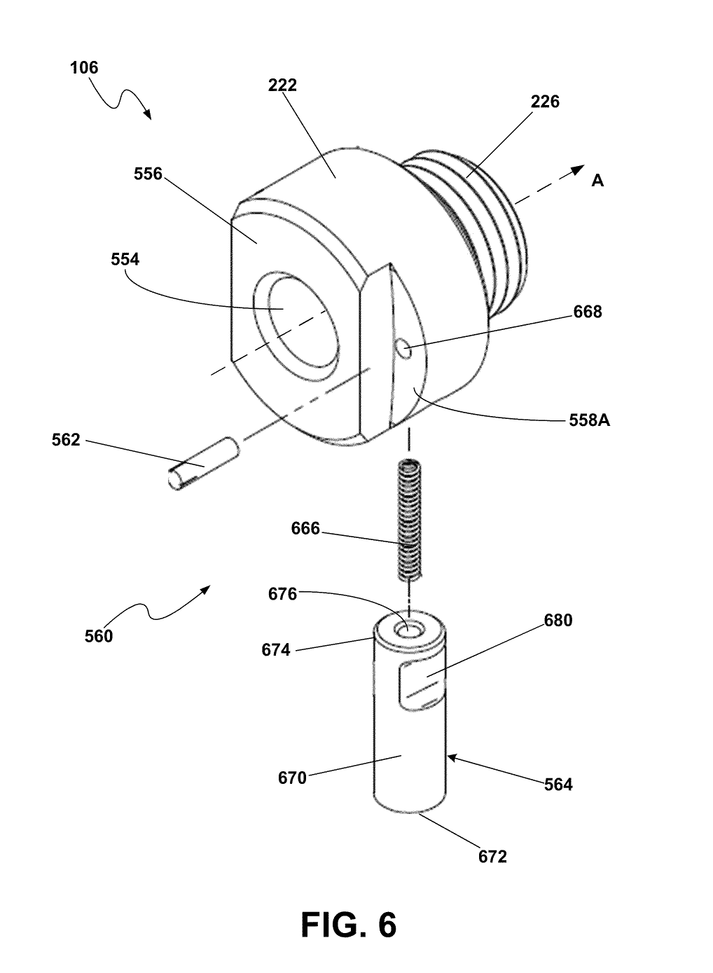

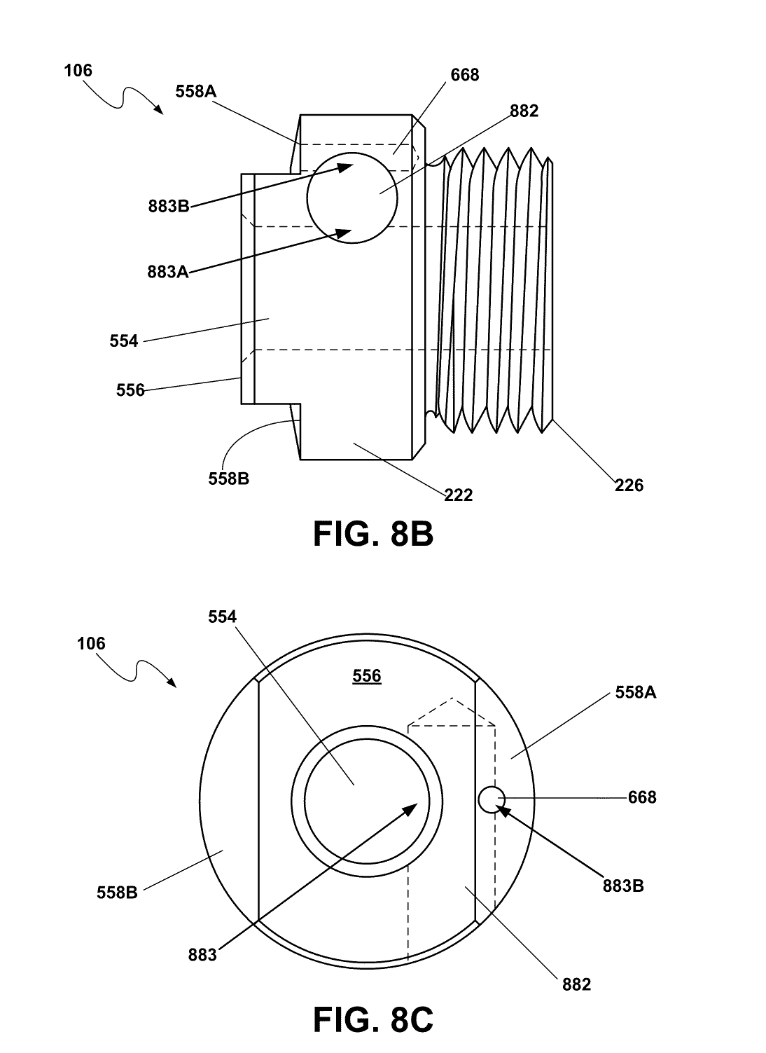

In the illustrated embodiment, the collar surface 218 of the tool-bit holder 102 may include a first rigid member 350A and a second rigid member 350B extending from the distal end 214 of the body 210. The first and second rigid members 350A, 350B may oppose one another, as shown in FIG. 3. A recessed portion 349 may be defined between the first and second rigid members 350A, 350B. The first and second rigid members 350A, 350B may define first and second contact surfaces 351A, 351B, respectively, configured to make contact and engage first and second recessed portions 558A, 558B (shown in FIGS. 8B-8C and described in greater detail below) defined on the surface 228 of the proximal end 224 of the arbor 106 when the arbor 106 is securely coupled via the locking mechanism 560 (shown in FIGS. 5-6 and described in greater detail below) to the drill bit 104. Additionally, the recessed portion 349 may be shaped and/or sized to receive and matingly engage a protruding portion 556 (shown in FIG. 5) defined between the first and second recessed portions 558A, 558B and extending from the proximal end 224 of the arbor 106 when the arbor is securely coupled to the drill bit 104.

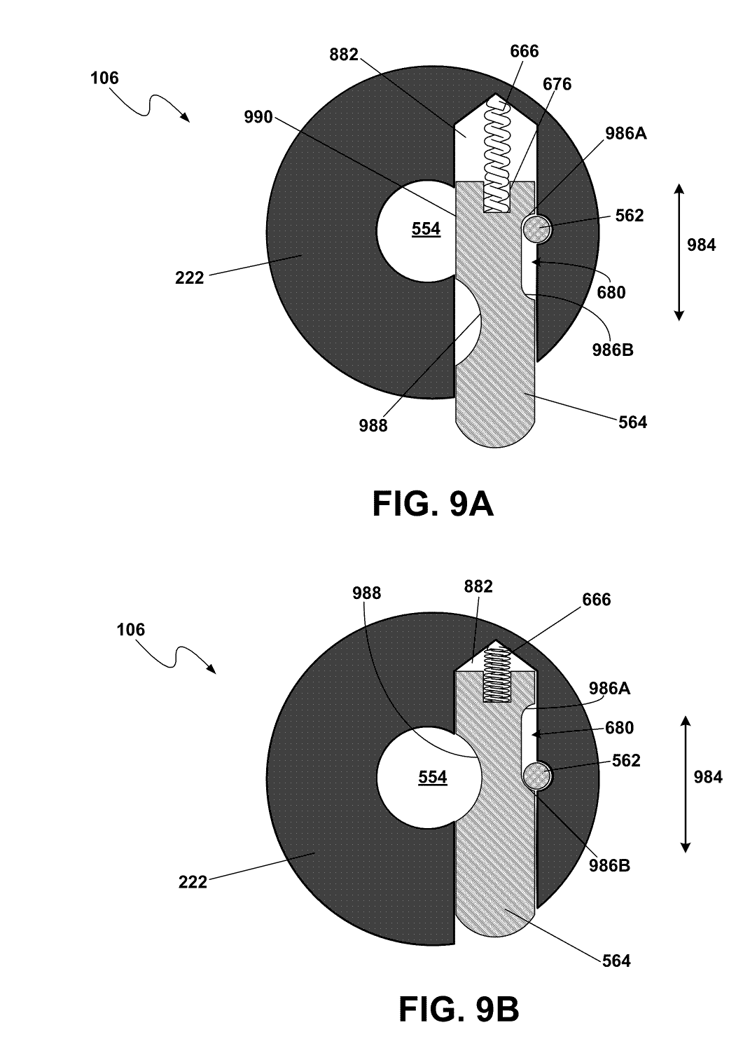

FIG. 4 is a side view of the drill bit of the system of FIG. 1. As can most clearly be seen in FIG. 4, the drill bit 104 may include a body 240 having a longitudinal axis of rotation extending between an operative distal end 244 and an opposite proximal end 242. In the illustrated embodiment, a groove 452 may be defined on the body 244, wherein the groove 452 may extend circumferentially on at least a portion of the body 240. The groove 452 may have a width W, wherein width W may be shaped and/or sized to accommodate a portion of the locking mechanism 560 of the arbor 106. In particular, the width W may be shaped and/or sized to accommodate a portion 990 (shown in FIG. 9A) of a body 670 of a release button 564 (shown in FIG. 6). The groove 452 may be configured to retain and securely coupled the arbor 106 to the drill bit 102 via the locking mechanism 560 of the arbor 106.

FIG. 5 is a perspective view of the arbor 106 of the system of FIG. 1. In the illustrated embodiment, the surface 228 of the proximal end 224 may include first and second recessed portions 558A, 558B (second recessed portion 558B shown in FIGS. 8B-8C), wherein a protruding portion 556 may be defined between the first and second recessed portions 558A, 558B. When the arbor 106 is securely coupled to the drill bit 104 (via the locking mechanism 560 engaged with the groove 452), the first and second recessed portions 558A, 558B may be configured to receive and matingly engage the first and second rigid members 350A, 350B of the tool-bit holder 102. It should be noted that either of the first and second rigid members 350A, 350B may be configured to matingly engage with either of the first and second recessed portions 558A, 558B. Additionally, the protruding portion 556 may be configured to fit within and matingly engage the recessed portion 349 when the arbor 106 is coupled to the drill bit 104.

In the illustrated embodiment, the distal end 226 may define threads having sufficient size and pitch so as to be able to accept and be coupled to the hole saw. The distal end 226 may be configured to engage a corresponding threaded aperture in the a proximal end 232 of the saw blade 108 and secure the saw blade 108 to the arbor 106. Additionally, the arbor 106 may include a locking mechanism 560 configured to engage and secure the arbor 106 to at least a portion of a drill bit 104. The locking mechanism 560 may include a fastener, e.g. pin 562, configured to retain a release button 564 and a spring 666 (shown in FIG. 6) within a portion of the body 222 of the arbor 106.

FIG. 6 is an exploded view of the arbor 106 of the system of FIG. 1. In the illustrated embodiment, a first cavity 668 may be defined on a portion of the body 222 of the arbor 106. The first cavity 668 may be shaped and/or sized to receive the pin 562. Additionally, a second cavity 882 (shown in FIGS. 8A-8C) may be defined on a portion of the body 222. The second cavity 882 may be shaped and/or sized to receive the spring 666 and at least a portion of the release button 564. In the illustrated embodiment, the release button 564 may include a body 670 having a proximal end 672 and a distal end 674. The proximal end 672 may be configured to extend from the second cavity and the body 222 of the arbor 106 when the release button is in a first release button position (shown in FIG. 5). The distal end 674 may define a third cavity 676 shaped and/or sized to receive a portion of the spring 666. The body 670 of the release button 564 may also define a first surface 680 extending along a portion of the length of the release button 564. The first surface 680 may be a cammed surface configured to provide a contact surface for the pin 562 when the release button 564 moves from a first release member position to a second release member position (shown in FIGS. 9A-9B). When the locking mechanism 560 is fully assembled within the body 222 (shown in FIGS. 9A-9B), the pin 562 is configured to retain the spring 666 and a portion of the release button 564 in the second cavity 882 via contact with the first surface 680 of the release button 564.

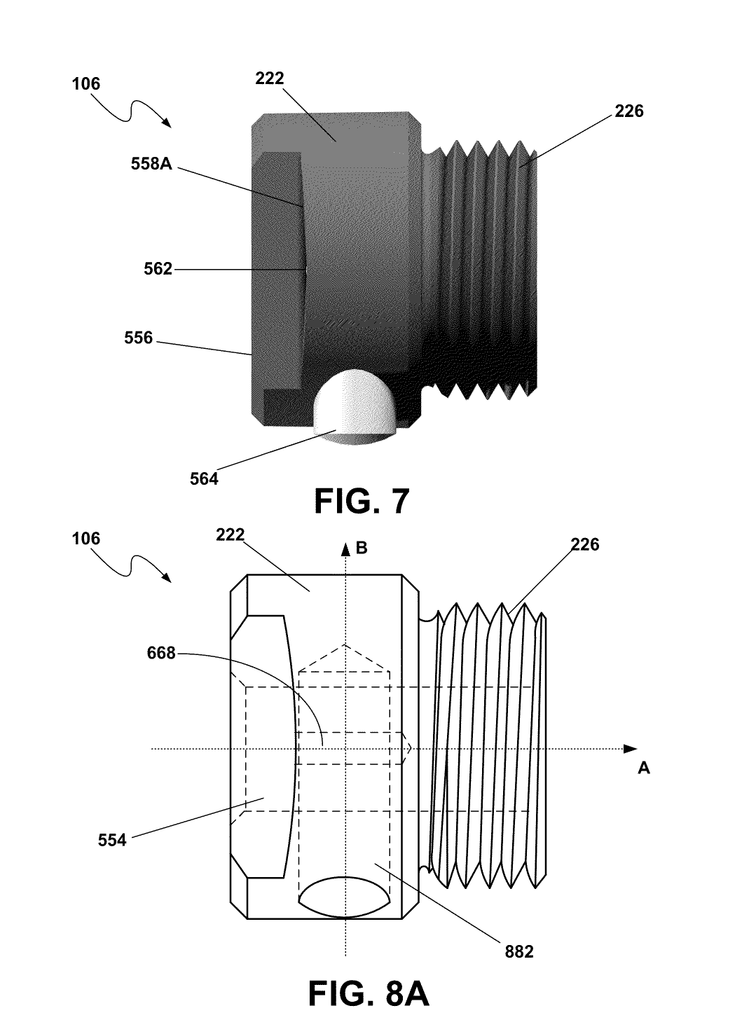

FIG. 7 is a side view of the arbor of the system of FIG. 1 and FIGS. 8A-8C are side, bottom and rear (proximal end facing) views, respectively, of the arbor of FIG. 7. It should be noted that internal features and/or surfaces are illustrated in phantom in FIGS. 8A-8C. Referring to FIG. 8A, the second cavity 882 formed in the body 222 is shown. The second cavity 882 may provide an axis B, generally perpendicular to axis A on a longitudinal plane, wherein the release button 564 may move from a first release button position to a second release button position. Referring to FIGS. 8B-8B, the first and second recessed portions 558A, 558B of the arbor 106 are more clearly shown. Additionally, it can be more clearly seen that a portion of the second cavity 882 intersects a portion of the longitudinal bore 554 indicated by the arrow 883A, such that a portion of the body 670 of the release button 564 is positioned within a portion of the longitudinal bore 554 (shown in FIG. 9A) when the locking mechanism 560 is fully assembled and the release button 564 is in the first release button position. Additionally, it can be more clearly seen that a portion of the second cavity intersects a portion of the first cavity 668 indicated by the arrow 883B, such that a portion of the pin 562 is positioned within a portion of the second cavity 882 (shown in FIGS. 9A-9B) when the locking mechanism 560 is fully assembled.

FIGS. 9A-9B are rear (proximal end facing) sectional views of the arbor of FIG. 7. FIG. 9A depicts the release button of the locking mechanism in a first release button position and FIG. 9B depicts the release button of the locking mechanism in a second release button position. The arbor 106 may be configured to be removed rapidly from the tool-bit holder 102 and drill bit 104 via the locking mechanism 560. The release button 564 may be configured to move between a first release button position (shown in FIG. 9A) and a second release button position (as shown in FIG. 9B) as indicated by the double arrow 984. When the release button 564 is in a first release button position, most clearly shown in FIG. 9A, the arbor 106 may be securely coupled to the drill bit 104 and the tool-bit holder 102. When the release button is in a second release button position, most clearly shown in FIG. 9B, the arbor 106 may be removed from the drill bit 104 and tool-bit holder 102.

Referring to FIG. 9A, when the locking mechanism 560 is fully assembled, the pin 562 is configured to engage the first surface 680 of the release button 564 and retain the release button 564 and spring 666 within at least the second cavity 882. The spring 666 may be provided to create a spring bias force that urges the release button 564 in a linear direction along axis B towards the first release button position. The spring 666 may include a flexible metal wire or a high-strength elastic material and have a general helical shape. The first surface 680 may include a first contact surface 986A and a second contact surface 986B. The first contact surface 986A may be configured to make contact with the pin 562 and may be shaped and/or sized to allow the pin 562 to retain the release button 564 and spring 666 within at least the second cavity 882 when the release button 564 is in the first release button position, shown in FIG. 9A. Additionally, the second contact surface 986B may be configured to make contact with the pin 562 and may be shaped and/or sized to allow the pin 562 to retain the release button 564 and spring 666 within at least the second cavity 882 when the release button 564 is in the second release button position, shown in FIG. 9B.

As described earlier, a portion of the release button 564 may be configured to engage at least a portion of the drill bit and couple at least a portion of the arbor 106 to the drill bit 104, effectively locking the arbor 106 in place. In the illustrated embodiment, a portion 990 of the release button 564 may be configured to be received within the groove 452 of the drill bit 104 when the release button 564 is in the first release button position, thereby securely coupling the arbor 106 to the drill bit 104.

The locking mechanism 560 may also be configured to allow the release of the arbor 106 from the drill bit 104. As can most clearly be seen in FIG. 9B, a second surface 988 may be defined on a portion of the release button 564. The second surface 988 may extend along a portion of the length of the release button 564 and may be shaped and/or sized to allow a portion of the drill bit 104 to pass through the longitudinal bore 554 of the arbor 102 when the release button 564 is in the second release button position. As shown, when the release button 564 is in the second release button position, the second surface 988 is configured to allow the release button 564 to disengage from the drill bit 104. In particular, the portion 990 moves and is no longer positioned within the bore 554. Instead, the second surface 988 is configured to allow the drill bit 104 to freely move within the bore 554. In the illustrated embodiment, the second surface 988 is configured to form a complementary interior surface of the longitudinal bore 554, thereby allowing the drill bit 104 to freely pass through. It should be noted that the second surface 988 may include any shape and/or size to allow the drill bit 104 freely move within the bore 554. When a user desires to disengage the arbor 106 from the drill bit 104 and tool-bit holder 102, the user need only move the release button 564 from the first release button position to the second release button position, compressing the spring 666, thereby positioning the second surface 988 in line with the longitudinal bore 554. The portion 990 of the release button 564 is no longer engaged with the groove 452 of the drill bit 104 when the release button is in the second release button position, thereby allowing a user to disconnect the arbor 106 from the drill bit 104.

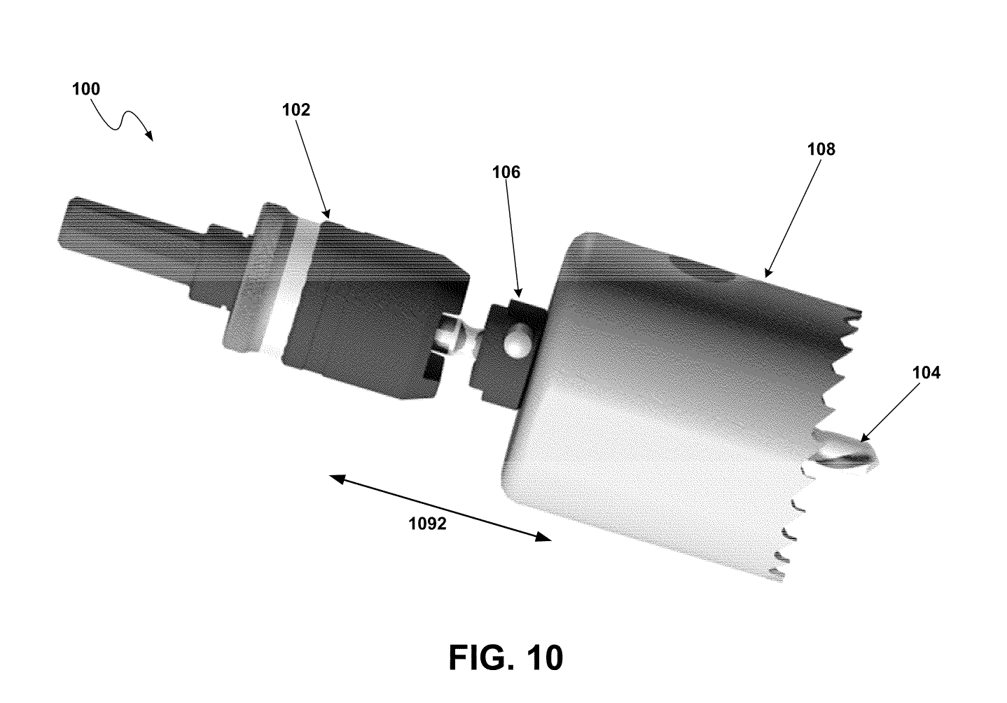

FIG. 10 is a side view of the hole saw arbor system of FIG. 1 with the locking mechanism of the arbor disconnected from the drill bit. As can most clearly be seen, the drill bit 104 may be positioned and received within a longitudinal bore (not shown) of the tool-bit holder 102. The tool-bit holder 102 may comprise a quick release chuck configured to automatically capture tool-bits as they are inserted into the longitudinal bore. In one embodiment, the drill bit 104 may define a hexagonal shank and may be locked into position within the quick release chuck. Additionally, the arbor 106 and saw blade 108 may be assembled and then coupled to the drill bit 104. The arbor 106 and saw blade 108 may be slid down over the drill bit 104 and may be locked/unlocked in a direction indicated by arrow 1092. When the arbor 106 is coupled to the drill bit 104 via the locking mechanism described earlier, the complementing ends (surfaces and/or features of the distal end 214 of the tool-bit holder 102 and the proximal end 224 of the arbor 106) may be located and matingly engaged with one another. In order to securely couple the arbor 106 in place, the arbor 106 may be slid over the drill bit 104 until at least a portion of the release button 564 locates and engages a groove 452 defined on a surface of the drill bit 104. When a hole saw change (arbor/saw blade) is required and/or desired, the release button 564 may be pressed, moving the release button 564 from a first release button position to a second release button position, thereby disengaging and releasing the arbor 106 from the drill bit 104. The arbor 106 may then be removed, while the drill bit 104 may remain locked in place in the tool-bit holder 102.

In one aspect, the present disclosure may feature an arbor. The arbor may be configured to be releasably coupled to a drill bit. The arbor may include a body having a proximal end and a distal end, the proximal end configured to matingly engage at least a portion of a tool-bit holder coupled to the drill bit when the arbor is coupled to the drill bit. The distal end may be configured to be coupled to a hole saw, wherein a substantially longitudinal bore extends from the proximal end to the distal end of the body, the bore being configured to receive the drill bit. The arbor may further include a locking mechanism positioned within a portion of the body, the locking mechanism configured to releasably couple the arbor to at least a portion of the drill bit when the drill bit is within the bore.

In yet another aspect, the present disclosure may feature a hole saw system. The hole saw system may include a tool-bit holder comprising a body having a proximal end and a distal end, the proximal end configured to be coupled to and driven by a driving device. A substantially longitudinal tool-bit holder bore may extend from the proximal end to the distal end of the body, the bore configured to receive a drill bit. The system may further include an arbor configured to be releasably coupled to a portion of the drill bit. The arbor may include a body having a proximal end and a distal end, the proximal end configured to matingly engage the distal end of the tool-bit holder when the arbor is coupled to the drill bit. The distal end may be configured to be coupled to a hole saw. A substantially longitudinal arbor bore may extend from the proximal end to the distal end of the body, the arbor bore being configured to receive the drill bit. The arbor may further include a locking mechanism positioned within a portion of the body, the locking mechanism configured to releasably couple the arbor to at least a portion of the drill bit when the drill bit is within the arbor bore.

In yet another aspect, the present disclosure may feature a hole saw system. The hole saw arbor system may include a driving device and a tool-bit holder comprising a body having a proximal end and a distal end, the proximal end coupled to and driven by the driving device. A substantially longitudinal tool-bit holder bore may extend from the proximal end to the distal end of the body, the bore configured to receive a drill bit. The system may further include an arbor configured to be releasably coupled to a portion of the drill bit. The arbor may include a body having a proximal end and a distal end, the proximal end configured to matingly engage the distal end of the tool-bit holder when the arbor is coupled to the drill bit. The distal end may be configured to be coupled to a hole saw. A substantially longitudinal arbor bore may extend from the proximal end to the distal end of the body, the arbor bore being configured to receive the drill bit. The arbor may further include a locking mechanism positioned within a portion of the body, the locking mechanism configured to releasably couple the arbor to at least a portion of the drill bit when the drill bit is within the arbor bore.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed.

The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary. The terms “first,” “second,” and the like herein do not denote any order, quantity, or importance, but rather are used to distinguish one element from another, and the terms “a” and “an” herein do not denote a limitation of quantity, but rather denote the presence of at least one of the referenced item.

What is claimed is:

1. An arbor configured to be releasably coupled to a drill bit, said arbor comprising:
a body having a proximal end and a distal end, said proximal end configured to matingly engage at least a portion of a tool-bit holder coupled to said drill bit when said arbor is coupled to said drill bit and said distal end configured to be coupled to a hole saw, wherein a substantially longitudinal bore extends from said proximal end to said distal end of said body, said bore configured to receive said drill bit; and
a locking mechanism positioned within a portion of said body, said locking mechanism configured to releasably couple said arbor to at least a portion of said drill bit when said drill bit is within said bore.

2. The arbor of claim 1 wherein said locking mechanism comprises:
a fastener positioned within a first cavity defined on said body, said first cavity being substantially parallel to said bore; and
a release button positioned within a second cavity defined on said body, said second cavity being substantially perpendicular to said bore and said release button being configured to retain a spring within said second cavity, said fastener being configured to retain said release button and spring within said second cavity;
said release button being movable between a first release button position and a second release button position;
wherein, when said release button is in said first release button position, a first portion of said release button is configured to engage a groove circumferentially extending along a portion of said drill bit and securely couple said arbor to said drill bit and when said release button is in said second release button position, said first portion of said release button is configured to disengage from said groove of said drill bit and allow said arbor to be removed from said drill bit.

3. The arbor of claim 1 wherein said first portion of said release button is positioned within a portion of said bore when said release button is in said first release button position.

4. The arbor of claim 1 wherein said first portion of said release button moves from said portion of said bore to a portion of said second cavity when said release button is in said second release button position.

5. The arbor of claim 1 wherein said release button comprises a first surface extending along a portion of a length of said release button, said first surface being configured to provide a contact surface for said fastener to engage when said release button moves from said first release button position to said second release button position.

6. The arbor of claim 1 wherein said release button comprises a second surface extending along a portion of a length of said release button, said second surface being configured to allow said release button to disengage said drill and allow said drill bit to move freely within said bore.

7. The arbor of claim 1 wherein said surface of said proximal end of said arbor comprises first and second recessed portions configured to receive and matingly engage first and second rigid members defined on said at least a portion of said tool-bit holder.

8. The arbor of claim 7 wherein a protruding portion is defined between said first and second recessed portions of said proximal end of said arbor, said protruding portion configured to be received within and matingly engage a recessed portion defined between said first and second rigid members of said at least a portion of said tool-bit holder.

9. A hole saw arbor system comprising:
a tool-bit holder comprising a body having a proximal end and a distal end, said proximal end configured to be coupled to and driven by a driving device, wherein a substantially longitudinal tool-bit holder bore extends from said proximal end to said distal end of said body, said tool-bit holder bore configured to receive a drill bit; and
an arbor configured to be releasably coupled to a portion of said drill bit, said arbor comprising:
a body having a proximal end and a distal end, said proximal end configured to matingly engage said distal end of said tool-bit holder when said arbor is coupled to said drill bit, said distal end configured to be coupled to a hole saw, wherein a substantially longitudinal arbor bore extends from said proximal end to said distal end of said body, said arbor bore configured to receive said drill bit; and
a locking mechanism positioned within a portion of said body, said locking mechanism configured to releasably couple said arbor to at least a portion of said drill bit when said drill bit is within said arbor bore.

10. The system of claim 9 wherein said locking mechanism comprises:
a fastener positioned within a first cavity defined on said body, said first cavity being substantially parallel to said arbor bore; and
a release button positioned within a second cavity defined on said body, said second cavity being substantially perpendicular to said arbor bore and said release button being configured to retain a spring within said second cavity, said fastener being configured to retain said release button and spring within said second cavity;
said release button being movable between a first release button position and a second release button position;
wherein, when said release button is in said first release button position, a first portion of said release button is configured to engage a groove circumferentially extending along a portion of said drill bit and securely couple said arbor to said drill bit and when said release button is in said second release button position, said first portion of said release button is configured to disengage from said groove of said drill bit and allow said arbor to be removed from said drill bit.

11. The system of claim 9 wherein said tool-bit holder comprises a quick-release mechanism configured to secure said drill bit to said tool-bit holder.

12. The system of claim 9 wherein said first portion of said release button is positioned within a portion of said arbor bore when said release button is in said first release button position.

13. The system of claim 9 wherein said first portion of said release button moves from said portion of said arbor bore to a portion of said second cavity when said release button is in said second release button position.

14. The system of claim 9 wherein said release button comprises a second surface extending along a portion of a length of said release button, said second surface being configured to allow said release button to disengage said drill and allow said drill bit to move freely within said arbor bore.

15. The system of claim 9 wherein said surface of said proximal end of said arbor comprises first and second recessed portions configured to receive and matingly engage first and second rigid members defined on said distal end of tool-bit holder.

16. The system of claim 15 wherein a protruding portion is defined between said first and second recessed portions of said proximal end of said arbor, said protruding portion configured to be received within and matingly engage a recessed portion defined between said first and second rigid members of said distal end of said tool-bit holder.

17. The system of claim 16 wherein, when driven by a driving device, at said first and second rigid members and said recessed portion defined between said first and second rigid members of said distal end of said tool-bit holder are configured to matingly engage said first and second recessed portions and said protruding portion of said proximal end of said arbor and drive said arbor, thereby driving said hole saw.

18. A hole saw system comprising:
a driving device;
a tool-bit holder comprising a body having a proximal end and a distal end, said proximal end coupled to and driven by said driving device, wherein a substantially longitudinal tool-bit bore extends from said proximal end to said distal end of said body, said tool-bit bore configured to receive a drill bit; and
an arbor configured to be releasably coupled to a portion of said drill bit, said arbor comprising:
a body having a proximal end and a distal end, said proximal end configured to matingly engage said distal end of said tool-bit holder when said arbor is coupled to said drill bit, said distal end configured to be coupled to a hole saw, wherein a substantially longitudinal arbor bore extends from said proximal end to said distal end of said body, said arbor bore configured to receive said drill bit; and
a locking mechanism positioned within a portion of said body, said locking mechanism configured to releasably couple said arbor to at least a portion of said drill bit when said drill bit is within said arbor bore.

19. The system of claim 18 wherein said locking mechanism comprises:
a fastener positioned within a first cavity defined on said body, said first cavity being substantially parallel to said arbor bore; and
a release button positioned within a second cavity defined on said body, said second cavity being substantially perpendicular to said arbor bore and said release button being configured to retain a spring within said second cavity, said fastener being configured to retain said release button and spring within said second cavity;
said release button being movable between a first release button position and a second release button position;
wherein, when said release button is in said first release button position, a first portion of said release button is configured to engage a groove circumferentially extending along a portion of said drill bit and securely couple said arbor to said drill bit and when said release button is in said second release button position, said first portion of said release button is configured to disengage from said groove of said drill bit and allow said arbor to be removed from said drill bit.

20. The system of claim 18 wherein said tool-bit holder comprises a quick-release mechanism configured to secure said drill bit to said tool-bit holder.
